(19) United States
(12) Patent Application Publication
(10) Pub. No.: US 2019/0320247 A1
(43) Pub. Date: Oct. 17, 2019

(54) WIRELESS COMMUNICATION ASSEMBLY FOR A SENSOR

(71) Applicant: Valeo Systems de Controle Moteur, Cergy Saint Christophe (FR)

(72) Inventors: Jean-Michel Marchisio, Mondeville (FR); Christopher Griz, Cergy Saint Christophe (FR)

(73) Assignee: Valeo Systemes de Controle Moteur, Cergy Saint Christophe (FR)

(21) Appl. No.: 16/469,919

(22) PCT Filed: Dec. 13, 2017
(86) PCT No.: PCT/FR2017/053550

§ 371 Date: Jun. 14, 2019

(30) Foreign Application Priority Data
Dec. 14, 2016 (FR) 1662411

(51) Int. Cl. H04Q 9/02; G01K 1/02

(52) U.S. Cl. CPC H04Q 9/02; G01K 1/024; G01K 2205/04; H04Q 2209/886; H04Q 2209/40

(57) ABSTRACT

The present invention relates to a wireless communication assembly (1) for a sensor (2) for measuring a magnitude in a motor vehicle. The sensor (2) comprises, at a first end portion (3), an element sensing (5) the magnitude to be measured in the motor vehicle and, at a second end portion (4), an electrical connector (6) electrically connected to the sensing element (5).

According to the invention, the wireless communication unit (1) comprises:
a transmission module (7) intended to be removably connected to the electrical connector (6) of the sensor (2), the transmission module (7) comprising means of wireless communication (8), and
a receiving module at a location remote from the transmission module (7) and comprising means of wireless communication for receiving data transmitted by the transmission module (7).

The present invention relates to a sensor wireless communication assembly for measuring magnitude in a motor vehicle and a sensor structure comprising such a wireless communication assembly.

In the field of motor vehicles, the use of sensors comprising a wireless communication assembly is known, in order to make measurements of physical quantities, such as temperature or pressure, for example, in a severe environment in which conventional sensors cannot be used due to extreme environmental conditions (high temperatures (above 900° C.), significant vibration, corrosive atmosphere).

The wireless communication assembly includes a radio frequency (RF) transmitter integrated within the sensor which communicates with an RF receiver at a location remote from the transmitter, positioned outside of the harsh environment. Communication is executed wirelessly. The receiver receives the measured magnitude data and transmits it to a control device.

Such means have the advantage of avoiding the use of electric cables to provide the connection between the sensor and the control device.

However, the integration of the RF transmitter within the sensor necessarily requires the replacement of the RF transmitter in case of sensor failure or the replacement of the complete sensor in the event of RF transmitter failure, which is expensive and results in additional maintenance times.

In addition, the use of such sensors incorporating an RF transducer requires the use of specific, non-standard products, increasing the number of constituant parts required.

Also, the implementation of wireless sensors allows comprehensive validation of the measurement system.

The invention therefore aims to overcome these disadvantages in the prior art by providing a sensor wireless communication assembly for measuring a magnitude in a motor vehicle and a sensor structure comprising such a wireless communication assembly, allowing the manufacturing and maintenance process to be simplified by using standard sensors.

The invention relates to a sensor wireless communication assembly for measuring a magnitude in a motor vehicle. The sensor comprises, at a first end portion, an element sensing the magnitude to be measured in the motor vehicle and, at a second end portion, an electrical connector electrically connected to the sensing element.

According to the invention, the wireless communication assembly comprises a transmission module intended to be removably connected to the electrical connector of the sensor. The transmission module comprises means for wireless communication.

The wireless communication assembly also comprises a remote receiver module at a location remote from the transmission module and comprising means of wireless communication enabling it to receive data transmitted by the transmission module.

In a variant, the transmission module comprises an electrical connector intended to be electrically connected to the electrical connector of the sensor in a removable manner.

According to another variant, the means of wireless communication of the transmission module comprise an electronic device and an antenna powered by a means of a power supply.

According to a possible embodiment, the means of a power supply comprise an electric cable connecting the transmission module to a power source provided in the motor vehicle.

According to another possible embodiment, the means of a power supply comprise an independent power source integrated within the transmission module. The autonomous power source transforms a physical magnitude in the environment to be measured in the motor vehicle into electrical energy to self-power the transmission module.

In a variant, the physical magnitude is the temperature, the autonomous power source transforming the thermal energy into electrical energy.

In a variant, the physical magnitude is the magnetic field.

In a variant, the physical magnitude is the vibrational energy.

According to a possible embodiment, the sensor is a temperature, pressure or pressure and temperature, or flow rate sensor. The invention thus provides a sensor wireless communication assembly for measuring a magnitude in a motor vehicle and a sensor structure comprising such a wireless communication assembly to simplify the manufacturing and maintenance process using standard sensors.

The invention makes it possible to reduce maintenance times and costs.

It also makes it possible to avoid having electric cables provide communication between the sensor and the vehicle control device.

In case of sensor failure, it is possible to replace only the sensor without replacing the transmission module (RF transmitter for example).

Similarly, in case of failure of the transmission module, it is not necessary to replace all components. It is possible to replace only the transmission module by simply disconnecting it from the sensor and reconnecting a new transmission module to the sensor.

The transmission module may thus easily and quickly be disconnected and reconnected to the sensor.

It is possible to use standard sensors, avoiding having too many constituent parts.

The implementation of wireless sensors no longer entails the comprehensive validation of the measurement system.

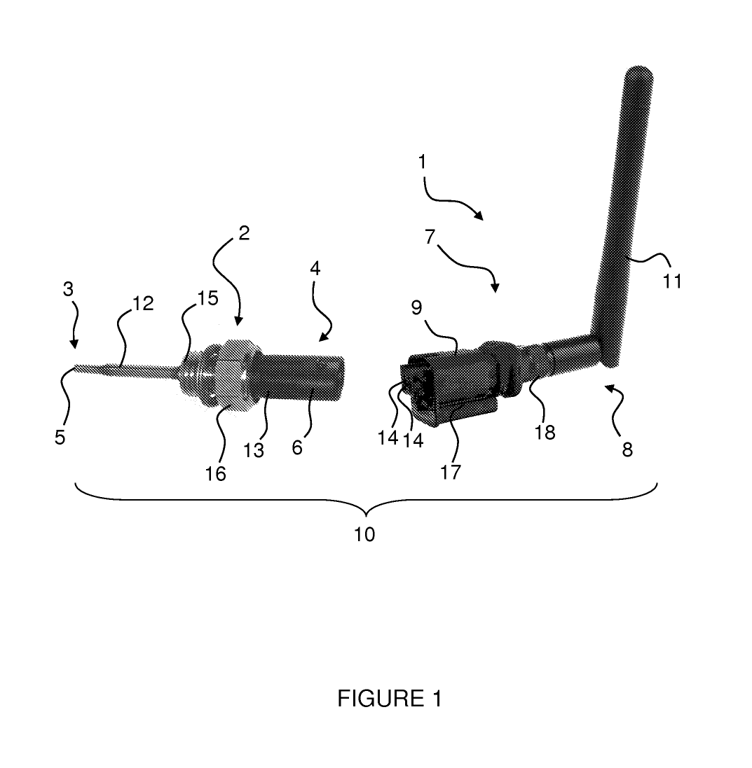

The features of the invention will be described in more detail with reference to unique FIG. 1:

FIG. 1 is a schematic representation of a sensor structure according to the invention.

FIG. 1 shows a sensor structure 10 for measuring a magnitude in a motor vehicle.

The sensor structure 10 comprises a sensor 2 comprising at a first end portion 3, an element 5 sensing the magnitude to be measured in the motor vehicle and at a second end portion 4, an electrical connector 6 electrically connected to the sensing element 5.

This type of electrical connector 6 is known. It is usually intended to be connected to another electrical connector connected to a control device via an electrical harness.

FIG. 1 shows a temperature sensor 2 as an example. The sensor 2 may alternatively be a pressure sensor, or a pressure and temperature sensor, or a flow sensor.

This type of sensor is known and is described in the patent application Valeo FR3035211.

Such temperature sensors 2 are in particular used in exhaust gas recirculation (EGR) systems.

The sensing element 5 is a temperature sensing element, such as a thermistor, connected externally to an electrical/electronic circuit operating a measurement signal via electrical wires.

The thermistor is housed in a protective envelope 12. The sensor 2 comprises two first electrical wires in contact with this thermistor which run along the protective envelope 12 to be accessible outside thereof and to provide electrical information representative of the resistance of the thermistor and, thereby, of the measured temperature.

For this purpose, the first electrical wires are connected by means of an electrical connection piece in the form of a lug, for example, to second electrical wires used to provide the electrical connection with the electrical connector 6, which is itself connected to the electrical/electronic circuit (control device).

The sensor 2 comprises a threaded portion 15 intended to be screwed into another threaded portion provided on an exhaust gas system duct and a stopper 16.

The electrical connector 6 is, in this example, a male connector comprising two pins surrounded by a protective envelope 13 of plastic.

The sensor structure 10 comprises a wireless communication unit 1 comprising a transmission module 7 intended to be removably connected to the electrical connector 6 of the sensor 2.

The transmission module 7 comprises means of wireless communication 8.

The wireless communication unit 1 also comprises a reception module which is remote from the transmission module 7.

The receiving module is positioned outside the medium in which the temperature measurement is carried out, that is to say out of the medium subjected to high temperatures.

The reception module comprises means of wireless communication enabling it to receive data transmitted by the transmission module 7.

The wireless communication may be radio frequency communication, for example.

The transmission module 7 comprises an electrical connector 9 intended to be electrically connected to the electrical connector 6 of the sensor 2 removably.

The two electrical connectors 6, 9 are easily connectable and disconnectable.

The electrical connector 9 of the transmission module 7 is a female connector, in this example, comprising two housings 14 intended to receive the two pins of the electrical connector 6 of the sensor 2.

The electrical connector 9 of the transmission module 7 comprises a plastic protective envelope 17 surrounding the two housings 14.

The means of wireless communication 8 of the transmission module 7 comprise an electronic device and an antenna 11 powered by means of a power supply.

According to a possible embodiment, the means of a power supply comprise an electric cable connecting the transmission module 7 to a remote power source provided in the motor vehicle.

According to another preferred embodiment, the means of a power supply comprise an independent power source integrated within the transmission module 7.

The autonomous power source transforms a physical magnitude in the environment to be measured in the motor vehicle into electrical energy to self-power the transmission module 7.

The physical magnitude is the temperature in this example. The thermal energy is transformed into electrical energy to supply power to the transmission module 7 and provide it with the energy necessary for the transmission by electromagnetic waves of the temperature data measured by the sensor 2.

In a variant, the transmission module 7 may comprise means for receiving radiofrequency energy transmitted by a remote transmitter. The means of receiving radiofrequency energy then transform the received electromagnetic waves into electrical energy for supplying the transmission module 7.

The means of wireless communication 8 of the transmission module 7 comprise means of fastening 18 for screwing the antenna 11 to the electrical connector 9.

The transmission module 7 is designed to withstand temperatures above 900° C.

1. A wireless communication assembly for a sensor for measuring a magnitude in a motor vehicle, comprising:
a transmission module removably connected to an electrical connector of the sensor, the transmission module comprising means of wireless communication,
said sensor comprising, at a first end portion, an element sensing the magnitude to be measured in the motor vehicle and, at a second end portion, the electrical connector electrically connected to the sensing element; and
a receiving module at a location remote from the transmission module and comprising means of wireless communication enabling the receiving module to receive data transmitted by the transmission module.

2. The wireless communication assembly according to claim 1, wherein the transmission module comprises an electrical connector configured to be electrically connected to the electrical connector of the sensor removably.

3. The wireless communication assembly according to claim 1, wherein the means of wireless communication of the transmission module comprise an electronic device and an antenna powered by an electrical supply.

4. The wireless communication assembly according to claim 3, wherein the electrical supply comprises an electrical cable connecting the transmission module to a power source provided in the motor vehicle.

5. The wireless communication assembly according to claim 3, wherein the electrical supply comprises an independent power source integrated within the transmission module, the autonomous power source transforming a physical magnitude in the environment to be measured in the motor vehicle to electrical energy to self-power the transmission module.

6. The wireless communication assembly according to claim 5, wherein the physical magnitude is the temperature, the autonomous power source transforming the thermal energy into electrical energy.

7. The wireless communication assembly according to claim 1, wherein the sensor is a temperature sensor.

8. A sensor structure for measuring a magnitude in a motor vehicle, said sensor structure comprising:
a sensor having at a first end portion, an element sensing the magnitude to be measured in the motor vehicle, and at a second end portion, an electrical connector electrically connected to the sensing element; and
a wireless communication assembly comprising:
a transmission module removably connected to the electrical connector of the sensor and comprising means of wireless communication, and
a receiving module at a location remote from the transmission module and comprising means of wireless communication enabling the receiving module to receive data transmitted by the transmission module.
